(19) United States
(12) Patent Application Publication
(10) Pub. No.: US 2006/0080272 A1
(43) Pub. Date: Apr. 13, 2006

(54) Apparatus, system, and method for data comparison

(76) Inventors: Ya-Huey Juan, San Jose, CA (US); Jeremy Leigh Royall, San Jose, CA (US)

Correspondence Address: KUNZLER & ASSOCIATES, 8 EAST BROADWAY, SUITE 600, SALT LAKE CITY, UT, 84111, US

(21) Appl. No.: 10/962,854

(22) Filed: Oct. 12, 2004

(51) Int. Cl. G06F 17/30

(52) U.S. Cl. 707/1

(57) ABSTRACT

An apparatus, system, and method are disclosed for comparing data objects within a plurality of data structures. The apparatus includes a comparison module and an identification module. The comparison module performs no more than a single comparison of each of a first plurality of data objects with each of a second plurality of data objects. The first and second pluralities of data objects may have at least one common data object. The identification module identifies all of the common data objects within the first and second pluralities of data objects. The identification module also may identify all of the unique data objects within the first and second pluralities of data objects.

### BACKGROUND

1. Technological Field

This invention relates to data comparison and more particularly relates to identifying common data objects among a plurality of data structures.

2. Background Technology

When processing two or more databases that each contains a plurality of data objects, it may be useful to determine which data objects are common and which data objects are unique to each database. For example, it may be useful to identify common data objects when combining two databases. In this way, a single copy of the common data objects may be included in the combined database, rather than unnecessarily duplicating the common data objects.

Database comparisons can require considerable processing resources, as well as time to perform the comparison. In a conventional database comparison, the first database is compared against the second database to identify all of the unique data objects in the first database. Subsequently, the second database is compared against the first database to identify all of the unique data objects in the second database. This two-way comparison is often performed using two double-for loops, where each double-for loop traverses the entire set of data objects in one database for each data object in the other database. Two double-for loops are used—one for the first database and one for the second database.

FIG. 1 depicts this conventional comparison. FIG. 1 includes a first data structure and a second data structure. These data structures may be databases, for example. The first data structure includes a plurality of data objects identified as A, B, C, D, E, F, G, and H. The second data structure includes another plurality of data objects identified as A, D, E, R, S, T, B, K, L, M, N, and H. The two pluralities of data objects include both common and unique data objects with respect to one another.

Conventionally, a comparator performs a first double-for loop to compare each of the data objects of the first data structure to all of the objects of the second data structure. This first double-for loop may be used to identify the data objects within the first data structure that are common with the data objects of the second data structure. Additionally, the first double-for loop may be used to identify the data objects within the first data structure that are unique (not common with the data objects of the second data structure). For example, after the first double-for loop, the comparator might identify A, B, D, E, and H as common data objects and C, F, and G as unique data objects.

The second double-for loop conventionally is employed to identify the data objects within the second data structure that are common with the data objects of the first data structure. The comparator also uses the second double-for loop to identify the unique data objects within the second data structure. For example, after the second double-for loop, the comparator might identify A, D, E, B, and H as common data objects and R, S, T, K, L, M, and N as unique data objects.

Unfortunately, the implementation of two double-for loops can be extremely taxing on the system, especially if the data structures are large or if the data access for each data object is time-consuming. In any event, the conventional implementation of two double-for loops is unnecessary and other ways of comparing data structures should be developed.

From the foregoing discussion, it should be apparent that a need exists for an apparatus, system, and method for comparing data objects within data structures. Beneficially, such an apparatus, system, and method would not require two-way comparison using two double-for loops. Additionally, such an apparatus, system, and method would advantageously reduce the processing and time demands that are required by conventional comparison technologies.

### SUMMARY

The several embodiments of the present invention have been developed in response to the present state of the art, and in particular, in response to the problems and needs in the art that have not yet been fully solved by currently available data comparison systems. Accordingly, the present invention has been developed to provide an apparatus, system, and method for data comparison that overcome many or all of the above-discussed shortcomings in the art.

The apparatus to compare data objects is provided with a logic unit containing a plurality of modules configured to functionally execute the necessary operation for asymmetric security. These modules in the described embodiments include a comparison module, an identification module, a bitmask module, and a pre-comparison module.

In one embodiment, the comparison module performs no more than a single comparison of each of the first plurality of data objects with each of the second plurality of data objects. In a further embodiment, the comparison module may perform only a single double-for loop to compare the first and second data structures. However, the comparison module may compare less than all of the first plurality of data objects with less than all of the second plurality of data objects. Additionally, the comparison module may exclude a data object from further comparisons after the data object has been identified as a common data object.

In one embodiment, the identification module identifies all of the common data objects within a plurality of data structures. The identification module also may identify all of the unique data objects of one or more data structures. In one embodiment, the identification module may identify the common data objects between two or more data structures by setting (or alternatively clearing) a common indicator within a bitmask of the associated data structures.

In one embodiment, the bitmask module creates a number of bitmasks that correspond to the data structures. In particular, the bitmask module may create a bitmask for each of the data structures that is or will be compared within a data object comparison system. Each of the bitmasks may have a plurality of common data object indicators, where the number of common data object indicators corresponds to the number of data objects within the corresponding data structure. In one embodiment, each of the common data object indicators corresponds to a single data object within a data structure. Furthermore, the bitmask module may initialize or reset all of the common data indicators within a single bitmask to a default value.

In one embodiment, the pre-comparison module determines if a data object is already identified as a common data object prior to comparison of the data object by the comparison module. Alternatively, the pre-comparison module may determine if a default indicator for the data object has been altered and, therefore, the data object does not need to be compared to another data object.

A system of the present invention is also presented to compare data objects. In one embodiment, the system may include a first data structure, a second data structure, and a comparison apparatus. The first data structure includes a first plurality of data objects. Similarly, the second data structure includes a second plurality of data objects. The comparison apparatus is similar to the apparatus described above. In another embodiment, the system may specifically include a bitmask module to create a bitmask for each of the data structures. In another embodiment, the system also may include one or more electronic storage devices on which the data structures and/or the bitmasks may be stored.

A signal bearing medium is also presented to store a program that, when executed, performs operations to compare data objects. In one embodiment, the operations include performing no more than a single comparison of each of a first plurality of data objects with each of a second plurality of data objects, and identifying all of the common data objects within the first and second pluralities of data objects. The first and second pluralities of data objects may have at least one common data object. However, in other embodiments, the first and second pluralities of data objects no common data objects. Additionally, the first and second pluralities of data objects may have one or more unique data objects. In another embodiment, the operations also may include creating the bitmasks, creating the common data object indicators, initializing the common data object indicators, setting the common data object indicators, and/or determining if a data object is already identified as a common data object.

A method of the present invention is also presented for comparing data objects. The method in the disclosed embodiments substantially includes the operations necessary to carry out the functions presented above with respect to the operation of the described apparatus and system. Furthermore, some or all of the operations of the method may be substantially similar to the operations that are performed when the program on the signal bearing medium is executed.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a conventional data structure comparison system;

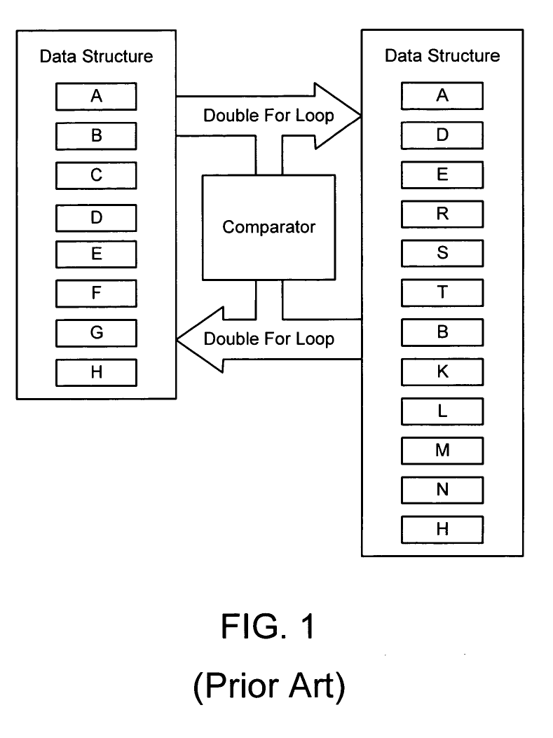

FIG. 2 is a schematic block diagram illustrating one embodiment of data object comparison system;

FIG. 3 is a schematic block diagram illustrating one embodiment of a comparison apparatus;

FIGS. 4A and 4B are schematic block diagrams illustrating embodiments of bitmasks that may be used in conjunction with the comparison apparatus of FIG. 3;

FIG. 5 is a schematic block diagram illustrating one embodiment of an exemplary bitmask set at the beginning of a comparison operation;

FIG. 6 is a schematic block diagram illustrating another embodiment of an exemplary bitmask set during a comparison operation;

FIG. 7 is a schematic block diagram illustrating another embodiment of an exemplary bitmask set after a comparison operation;

FIG. 8 is a schematic flow chart diagram illustrating one embodiment of a comparison method that may be implemented on a data object comparison system; and

FIG. 9 is a schematic flow chart diagram illustrating another embodiment of a comparison method that may be implemented on a data object comparison system.

### DETAILED DESCRIPTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

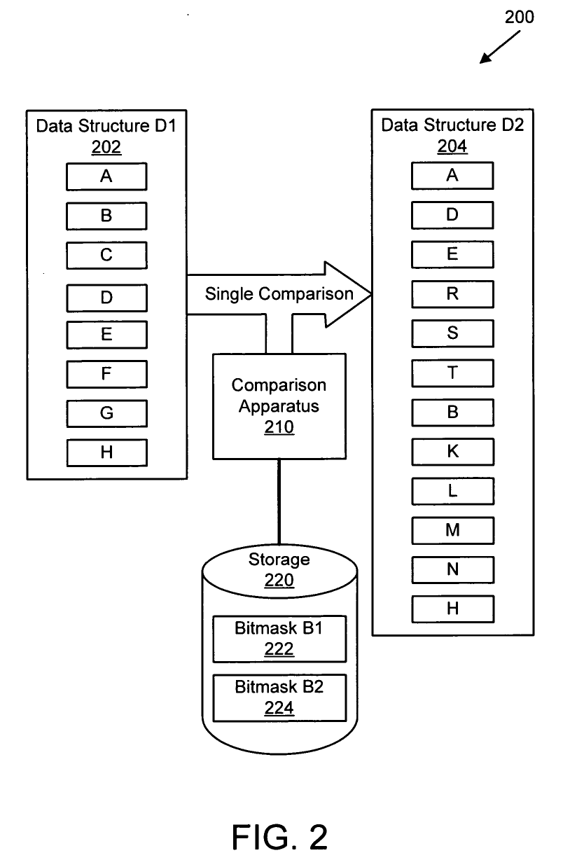

FIG. 2 depicts one embodiment of data object comparison system 200. The illustrated data object comparison system 200 includes a first data structure 202 and a second data structure 204. The first data structure 202 and second data structure 204 are identified as data structure D1 202 and data structure D2 204, or simply D1 and D2, respectively. The first data structure 202 includes a first plurality of data objects, which are identified as A, B, C, D, E, F, G, and H. The depicted data objects A through H are representative of any type of data object, including files, directories, and so forth, that may be included in the first data structure 202. Similarly, the second data structure 204 includes a second plurality of data objects, which are identified as A, D, E, R, S, T, B, K, L, M, N, and H. The depicted second plurality of data objects are similarly representative of any type of data object, including files, directories, and so forth, that may be included in the second data structure 204.

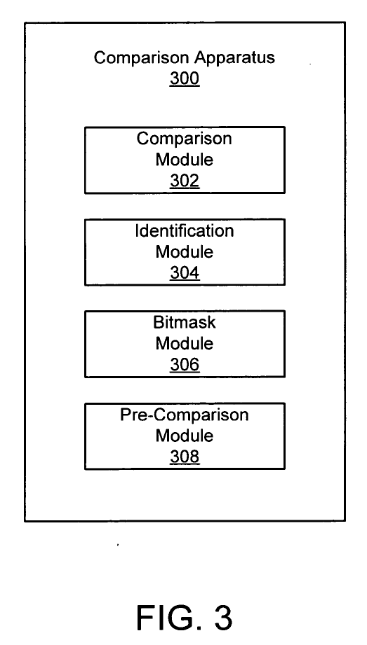

The illustrated data object comparison system 200 also includes a comparison apparatus 210 and an electronic storage device 220. One example of the comparison apparatus 210 is provided and described in more detail with reference to FIG. 3. In general, the comparison apparatus 210 performs a one-way, or single, comparison of the first and second pluralities of data objects to identify which data objects within each plurality are common and/or unique. However, it may be unnecessary for the comparison apparatus 210 to compare each of the data objects of the first data structure 202 to each of the data objects of the second data structure 204.

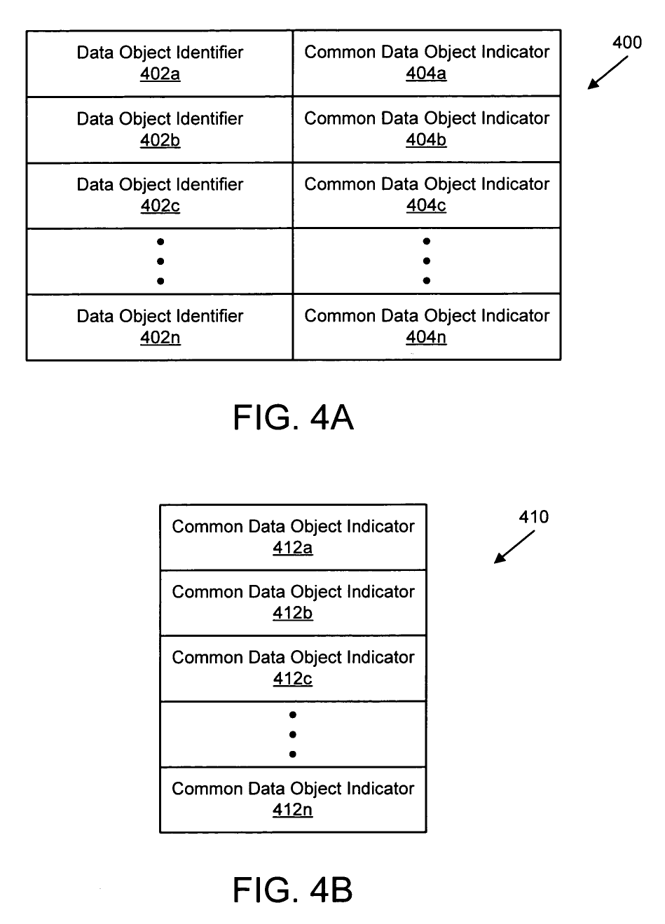

In one embodiment, the comparison apparatus 210 may be coupled to the electronic storage device 220 and may create, store, and/or maintain one or more bitmasks. For example, the comparison apparatus 210 may maintain a first bitmask B1 222 and a second bitmask B2 224 within the electronic storage device 220. Examples of various bitmasks are described in more detail with reference to FIGS. 4A and 4B. In one embodiment, the first bitmask B1 222 may be associated with the first data structure D1 202 and the second bitmask B2 224 may be associated with the second data structure D2 204. In a further embodiment, the comparison apparatus 210 may maintain one bitmask for each data structure within the data object comparison system 200.

In an alternative embodiment, the comparison apparatus 210 may be coupled to an electronic memory device (not shown) in addition to or in place of the electronic storage device 220. For example, the bitmasks 222, 224 may be stored on an electronic memory device rather than the electronic storage device 220. In a further embodiment, any type of electronic storage or memory device may be used to store the bitmasks 222, 224. Additionally, the bitmasks 222, 224 may be stored on a plurality of electronic storage and/or memory devices.

FIG. 3 depicts one embodiment of a comparison apparatus 300 that may be substantially similar to the comparison apparatus 210 of FIG. 2. As described above, the comparison apparatus 300 may compare some or all of the data objects within a data structure to some or all of the data objects within one or more other data structures. The illustrated comparison apparatus 300 includes a comparison module 302, an identification module 304, a bitmask module 306, and a pre-comparison module 308.

In one embodiment, the comparison module 302 performs no more than a single comparison of each of the first plurality of data objects with each of the second plurality of data objects. The first and second pluralities of data objects may be compared with an expectation that the first and second pluralities of data objects have at least one common data object. In other words, the comparison module 302 may compare each of the data objects of the first data structure 202 with each of the data objects of the second data structure 204. In an exemplary embodiment, the comparison module 302 may perform only a single double-for loop to compare the first and second data structures.

However, the comparison module 302 may compare all or less than all of the first plurality of data objects with less than all of the second plurality of data objects. For example, the comparison module 302 may forego a comparison of two data objects where the pre-comparison module 308 determines beforehand that one of the data objects has already been identified as a common data object, as described below. In a further embodiment, the comparison module 302 may exclude a data object from further comparisons after the data object has been identified as a common data object.

In one embodiment, the identification module 304 identifies all of the common data objects within a plurality of data structures. The identification module 304 may identify the common data objects in response to a comparison by the comparison module 302. The identification module 304 also may identify all of the unique data objects of one or more data structures. The identification module 304 may identify the common data objects between two or more data structures, in one embodiment, by setting (or alternatively clearing) a common indicator within a bitmask 222, 224 of the associated data structure(s) 202, 204.

In one embodiment, the bitmask module 306 creates the first and second bitmasks 222, 224 that correspond to the first and second data structures 202, 204, respectively. In particular, the bitmask module 306 creates a bitmask for each of the data structures that is or will be compared within the data object comparison system 200. Each of the bitmasks may have a plurality of common data object indicators, where the number of common data object indicators corresponds to the number of data objects within the corresponding data structure. In one embodiment, each of the common data object indicators corresponds to a single data object within a data structure.

In a further embodiment, the bitmask module 306 may initialize or reset all of the common data indicators within a single bitmask to a default value, such as zero. In one embodiment, the default value indicates a unique data object. In this way, the value of the common data indicator may be changed only upon determination that a data object is a common data object. However, other default values and/or indicating schemes may be implemented to set a common data object indicator to another value.

In one embodiment, the pre-comparison module 308 determines if a data object is already identified as a common data object prior to comparison of the data object by the comparison module 302. Alternative, the pre-comparison module 308 may determine if a default indicator for the data object has been altered and, therefore, the data object does not need to be compared to another data object.

FIG. 4A depicts one embodiment of a bitmask 400 that may be used in conjunction with the comparison apparatus 300 of FIG. 3. As stated above, a bitmask 400 may be created and maintained for each data structure to be compared. The illustrated bitmask 400 includes a plurality of data object identifiers 402 and a corresponding plurality of common data object indicators 404. In one embodiment, the bitmask 400 includes one data object identifier 402 and one common data object indicator 404 for each data object in the associated data structure. In a further embodiment, the bitmask 400 also may include other data or metadata. For example, the bitmask 400 may include metadata to identify the data structure with which the bitmask 400 is associated. Additionally, the bitmask 400 may include metadata to identify the data structure(s) against which the associated data structure has been, is, or will be compared.

The data object identifier 402, in one embodiment, identifies the data object within the associated data structure. The common data object indicator 404, in one embodiment, indicates if the data object identified by the data object identifier 402 is a common data object with the data structure against which the associated data structure is compared. In another embodiment, the bitmask 400 may include other fields, indicators, identifiers, and so forth. For example, the bitmask 400 may include a unique data object identifier (not shown) in addition to or in place of the common data object indicator 404. The unique data object indictor may indicate if the corresponding data object is a unique data object, as opposed to a common data object.

The uniqueness and/or commonality of the data objects within various data structures may be determined based on one or more criteria. For example, in one embodiment, a data object may be identified as a common data object only if it is identical to another data object. In another embodiment, the data object may be identified as a common data object based on only partial similarity between the data objects. Partial similarity between two data objects may be defined in various ways including, but not limited to, size, content, type, ownership, date, and so forth.

In a similar manner, a data object may be identified as a unique data object in a complimentary manner—if it is not determined to be a common data object. However, in certain embodiments, some data objects may be defined as neither common nor unique, where the set of unique data objects includes fewer data objects than the compliment to the set of common data objects. In fact, certain embodiments may encompass the capability of determining various levels of commonality and/or uniqueness among data objects in different data structures.

FIG. 4B depicts another embodiment of a bitmask 410 that may be used in conjunction with the comparison apparatus 300 of FIG. 3. The illustrated bitmask 410 includes a plurality of common data object indicators 412. In one embodiment, the bitmask 410 includes one common data object indicator 412 for each data object in the associated data structure. In a further embodiment, the bitmask 410 also may include other data or metadata, as described above. The bitmask 410 may be advantageous over the bitmask 400 of FIG. 4A where the size of the bitmask 410 is reduced. However, other variations of bitmasks, including fewer or more fields, indicators, and so forth, may be implemented to accommodate a desired balance between performance and operational costs.

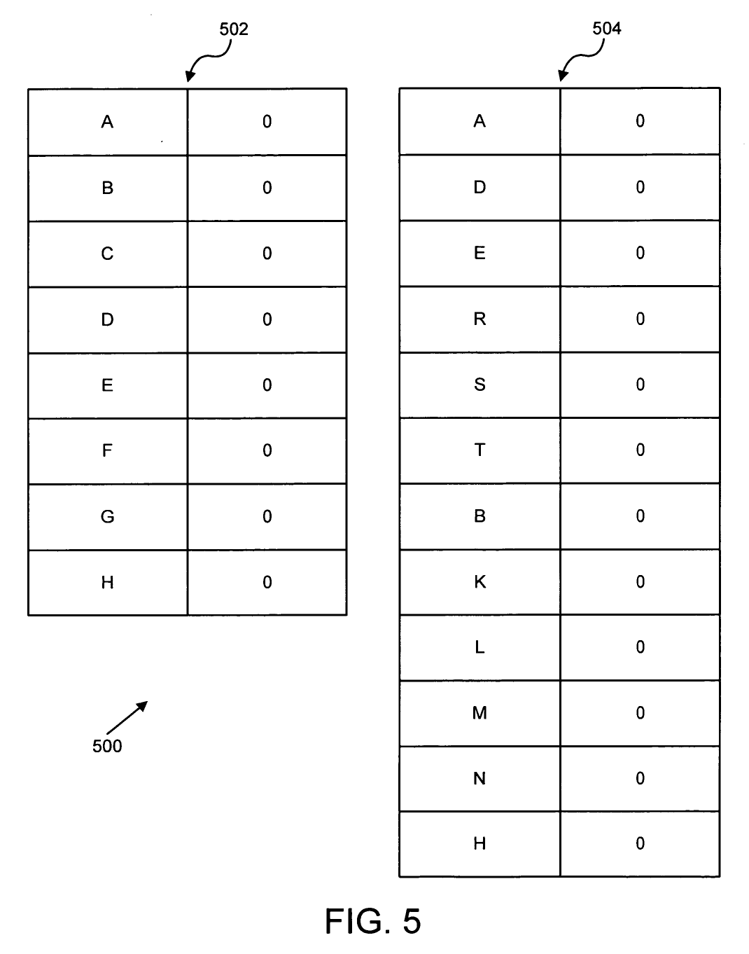

FIG. 5 depicts one embodiment of an exemplary bitmask set 500 at the beginning of a comparison operation. A bitmask set 500 is a set of two or more bitmasks that correspond to a similar number of data structures that have been, are, or will be compared, as described herein. The illustrated bitmask set 500 includes a first bitmask 502 and a second bitmask 504. For convenience in describing the several embodiments of the present invention, the first bitmask 502 may be associated with the data structure D1 202 of FIG. 2. Similarly, the second bitmask 504 may be associated with the data structure D2 204 of FIG. 2.

At some point in comparing the first and second data structures 202, 204, the comparison apparatus 210 may create the first and second bitmasks 502, 504. As described above with reference to FIGS. 4A and 4B, the comparison apparatus 210 may create bitmasks of various configurations. In fact, the bitmasks used for a single comparison of two data structures may be different from one another. The comparison apparatus 210 also may populate the bitmasks 502, 504 with default common data object indicators to indicate by default that all of the data objects in both of the data structures 202, 204 are either unique or common. In the present description, the value zero represents unique data objects and the value one represents common data objects, although other designations may be used. Upon creation of the first and second bitmasks 502, 504 within the illustrated bitmask set 500, all of the data objects may be identified, by default, as unique data objects.

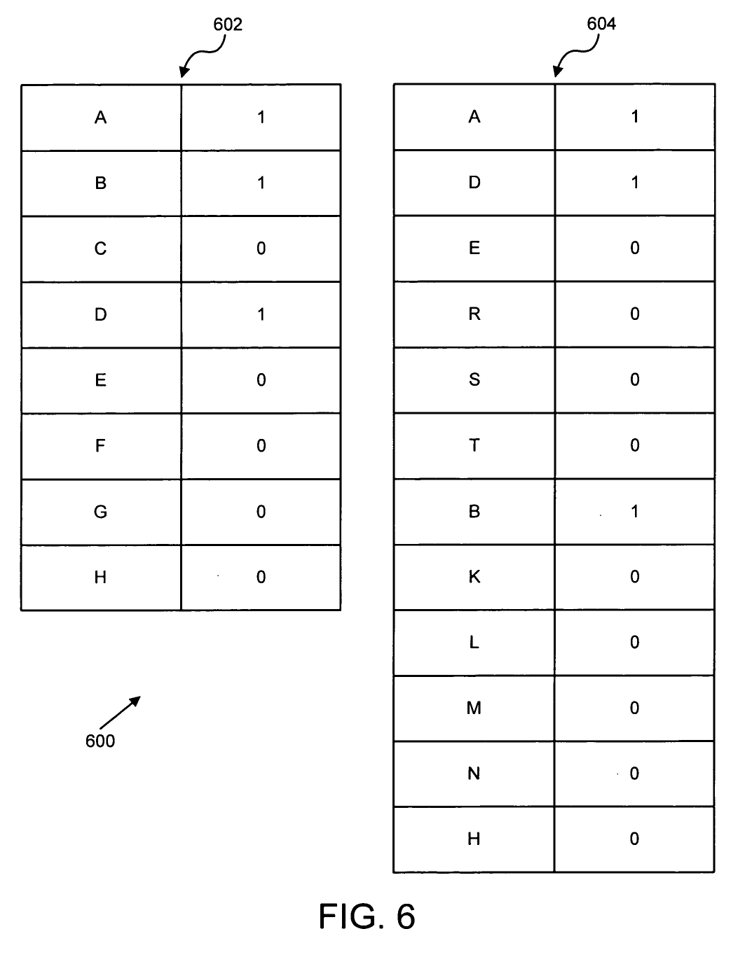

FIG. 6 depicts another embodiment of an exemplary bitmask set 600 during a comparison operation. In one embodiment, the bitmask set 600 may be substantially similar to the bitmask set 500, except that some of the data objects are identified as common data objects, where the common data object indicators are set to one. In particular, the first bitmask 602 indicates that the data objects A, B, and D are common data objects. Similarly, the second bitmask 604 indicates that the data objects A, D, and B are common data objects. However, not all of the common data objects between the first and second data structures 202, 204 are necessarily identified at this stage of the comparison.

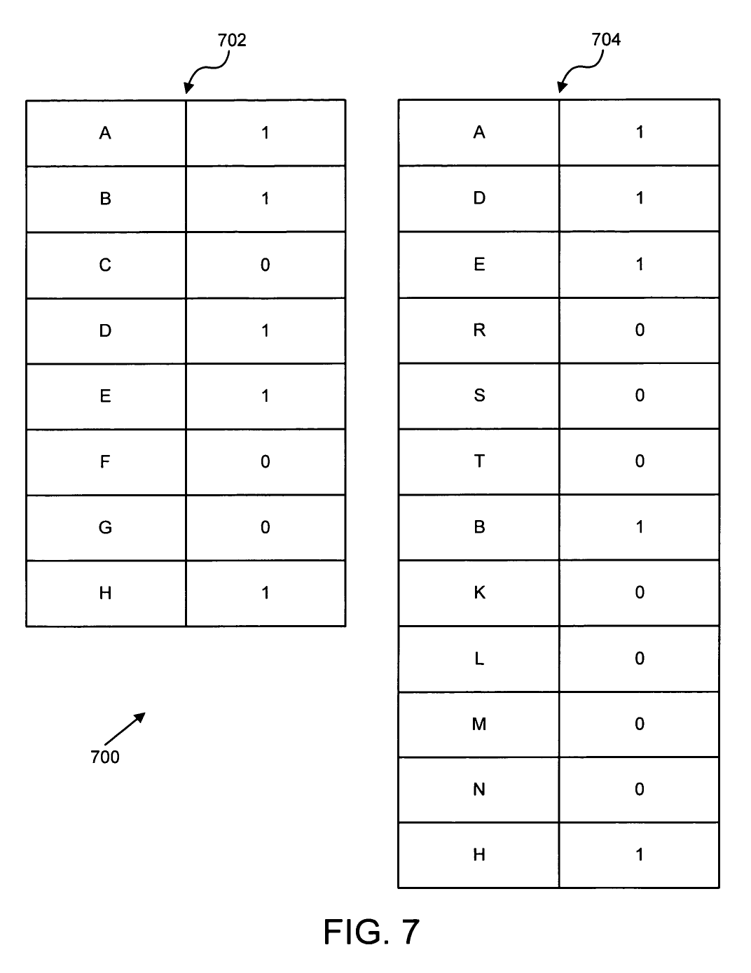

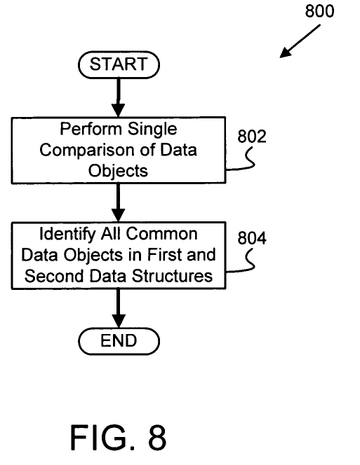

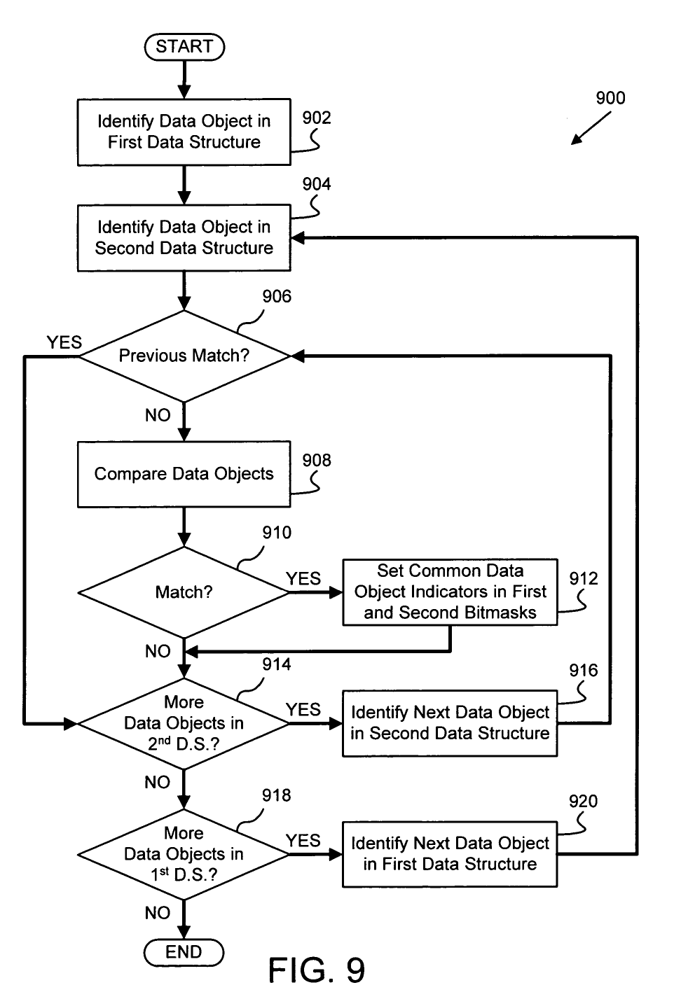

FIG. 7 depicts another embodiment of an exemplary bitmask set 700 after a comparison operation. In one embodiment, the bitmask set 700 may be substantially similar to the bitmask set 500, except that all of the common data objects are identified. In particular, the first bitmask 702 indicates that the data objects A, B, D, E, and H are common data objects. Similarly, the second bitmask 704 indicates that the data objects A, D, E, B, and H are common data objects. After the comparison of the first and second data structures 202, 204, the first and second bitmasks 702, 704 indicate all of the common data objects, as well as all of the unique data objects within each of the data structures 202, 204. One embodiment of how the comparison module 210 might establish this bitmask set 700 after only a single comparison between the data structures 202, 204 is described in more detail with reference to the following flow chart diagrams in FIGS. 8 and 9.

FIG. 8 depicts one embodiment of a comparison method 800 that may be implemented on the data object comparison system 200 of FIG. 2. The illustrated comparison method 800 begins by performing 802 a single comparison of the data objects of one data structure with the data objects of another data structure. For example, the data objects of the first data structure 202 of FIG. 2 may be individually compared to some or all of the data objects of the second data structure 204. As a result of such comparison, the comparison apparatus 210 is capable of identifying 804 all of the common data objects of the first and second data structures 202, 204. Additionally, the comparison module 210 may identify all of the unique data objects of the data structures 202, 204. The depicted comparison method 800 then ends.

FIG. 9 depicts a more detailed embodiment of a comparison method 900 that may be implemented on the data object comparison system 200 of FIG. 2. Although the description herein includes discussion of the first and second data structures 202, 204, certain embodiments of the comparison method 900 are applicable to comparisons of other data structures and comparisons among three or more data structures. Similarly, reference to the comparison apparatus 300 is understood to alternatively refer to any other comparison apparatus or corresponding comparison operation described herein.

The illustrated comparison method 900 begins when the comparison apparatus 300 identifies 902 a data object of the first data structure 202. The currently identified data object of the first data structure 202 is referred to herein as the first data object. The comparison apparatus 300 also identifies 904 a data object of the second data structure 204. The currently identified data object of the second data structure 204 is referred to herein as the second data object. In one embodiment, the comparison apparatus 300 employs the identification module 304 to identify 902, 904 the data objects.

The comparison apparatus 300 then determines 906 if the second data object is already identified as a common data object. This determination may be referred to herein as a pre-match determination. In one embodiment, the comparison apparatus 300 may employ the pre-comparison module 308 to access the corresponding common data object identifier within the second bitmask 224 in order to perform the pre-match determination 906.

If the second data object is not already identified as a common data object, the comparison apparatus 300 compares 908 the first and second data objects and determines 910 if the data objects match, or are similar enough to be considered common data objects. In one embodiment, the comparison apparatus 300 may employ the comparison module 302 to compare the first and second data objects. As described above, the scope of the comparison may be defined in various ways. For example, the comparison module 302 may determine 910 if the data objects are identical in size, content, ownership, date, and so forth. Alternatively, the comparison module 302 may determine 906 if the first and second data objects are identical. In another embodiment, the data objects may be deemed common if they are similar within a certain threshold, even though they are not identical.

If the data objects are determined 910 to match one another, then the comparison apparatus 300 may indicate 912 the commonality of the data objects in corresponding common data object indicators within the bitmasks 222, 224 associated with the data structures 202, 204. In one embodiment, the comparison apparatus 310 may employ the identification module 306 to set the corresponding common data object indicators within both the first and second bitmasks 222, 224.

After the data objects are identified 912 as common data objects, or if the data objects are not a match, the comparison apparatus 300 determines 914 if there are additional data objects within the second data structure 204. If there are additional data objects in the second data structure 204 that have not been compared with the first data object, the comparison apparatus 300 identifies 916 the next second data object and returns to determine 906 if the newly selected second data object is already identified as a common data object.

If there are no more data objects in the second data structure 204 that have not been compared with the first data object, the comparison apparatus 300 determines 918 if there are additional data objects within the first data structure 202. If there are additional data objects in the first data structure 202 that have not been compared with the data objects of the second data structure 204, the comparison apparatus 300 identifies 920 the next first data object and returns to identify 904 a second data object for comparison.

In this way, the comparison method 900 allows for each of the data objects within the first data structure 202 to be compared with each of the data objects within the second data structure 204. In one embodiment, however, it may be unnecessary to compare the first data object with one or more of the second data objects if a selected second data object is already identified as a common data object. Thus, the pre-match determination may save the time of an actual comparison of the data objects, thereby reducing the overall amount of time necessary for the comparison of the data structures.

In order to further reduce time, the comparison method 900 may be modified in one or more ways. In particular, after two data objects are determined 910 to be common data objects and are identified 912 as such, the comparison method 900 may skip further searching of the second plurality of data objects (e.g., operations 914 and 916). This embodiment of the comparison method 900 may be advantageous if it is unnecessary to individually identify all of the common data objects with the data structures 202, 204. A similar variation may apply to the following example.

The following example is provided to demonstrate one embodiment of the usefulness of the apparatus, system, and method described herein. Referring back to FIG. 2, the first data structure D1 202 may be compared with the second data structure D2 204. The following operations are set forth as one exemplary implementation of such a comparison:

```
<BEGIN>
  Identify D1-A
    Identify D2-A
      Pre-match D2-A? NO
      Match D2-A? YES
      Set Common Indicator in B1 for D1-A
      Set Common Indicator in B2 for D2-A
    Identify D2-D
      Pre-match D2-D? NO
      Match D2-D? NO
    (pre-match/compare D1-A with remaining D2 data objects -
    no match)
  Identify D1-B
    Identify D2-A
      Pre-match D2-A? YES
    Identify D2-D
      Pre-match D2-D? NO
      Match D2-D? NO
    (pre-match/compare D1-D with D2-E through D2-T - no match)
    Identify D2-B
      Pre-match D2-B? NO
      Match D2-B? YES
      Set Common Indicator in B1 for D1-B
      Set Common Indicator in B2 for D2-B
    (pre-match/compare D1-A with remaining D2 data objects -
    no match)
  Identify D1-C
    Identify D2-A
      Pre-match D2-A? YES
    Identify D2-D
      Pre-match D2-D? NO
      Match D2-D? NO
    (pre-match/compare D1-D with remaining D2 data objects -
    no match)
  Identify D1-D
    Identify D2-A
      Pre-match D2-A? YES
    Identify D2-D
      Pre-match D2-D? NO
      Match D2-D? YES
      Set Common Indicator in B1 for D1-D
      Set Common Indicator in B2 for D2-D
    (pre-match/compare D1-D with remaining D2 data objects -
    no match)
  Identify D1-E
    Identify D2-A
      Pre-match D2-A? YES
    Identify D2-D
      Pre-match D2-D? YES
    Identify D2-E
      Pre-match D2-E? NO
      Match D2-E? YES
      Set Common Indicator in B1 for D1-E
      Set Common Indicator in B2 for D2-E
    (pre-match/compare D1-E with remaining D2 data objects -
    no match)
  Identify D1-F
    (pre-match/compare D1-F with all D2 data objects - no match)
  Identify D1-G
    (pre-match/compare D1-G with all D2 data objects - no match)
  Identify D1-H
    (pre-match/compare D1-H with D2-A through D2-N - no match)
    Identify D2-H
      Pre-match D2-H? NO
      Match D2-H? YES
      Set Common Indicator in B1 for D1-H
      Set Common Indicator in B2 for D2-H
<END>
```

Advantageously, certain embodiments of the apparatus, system, and method presented above may be implemented to reduce the amount of time necessary to identify all of the common and/or unique data objects within a plurality of data structures. For example, the necessary time is reduced by 50% or more over conventional methods that employ two double-for loops. Certain embodiments also may save additional processing, data access, and comparison time where it is determined that a data object has already been identified as a match and, therefore, does not need to be compared against one or more data objects of another data structure.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to compare data objects, the apparatus comprising:
a comparison module configured to perform a single comparison of each of a first plurality of data objects with each of a second plurality of data objects; and
an identification module configured to identify every common data object within the first and second pluralities of data objects based on the single comparison.

2. The apparatus of claim 1, further comprising a bitmask module configured to create a first bitmask corresponding to a first data structure including the first plurality of data objects and to create a second bitmask corresponding to a second data structure including the second plurality of data objects.

3. The apparatus of claim 2, wherein the bitmask module is further configured to create a first plurality of common data object indicators within the first bitmask and to create a second plurality of common data object indicators within the second bitmask, each of the common data object indicators corresponding to a respective data object within the first and second pluralities of data objects.

4. The apparatus of claim 3, wherein the bitmask module is further configured to initialize all of the common data object indicators within the first and second bitmasks to indicate all unique data objects within both the first and second pluralities of data objects.

5. The apparatus of claim 4, wherein the bitmask module is further configured to initialize all of the common data object indicators to zero, where zero indicates by default that all of the data objects within the first and second pluralities of data objects are unique data objects.

6. The apparatus of claim 3, wherein the identification module is further configured to set a first common indicator within the first bitmask and to set a second common indicator within the second bitmask in response to identifying one of the common data objects, the first and second common indicators corresponding to the same common data object.

7. The apparatus of claim 6, wherein the identification module is further configured to set the first and second common indicators to one, where one indicates the same common data object.

8. The apparatus of claim 1, further comprising a pre-comparison module configured to determine, prior to comparison of a data object of the first plurality of data objects and a data object of the second plurality of data objects, if the data object of the second plurality of data objects is already identified as one of the common data objects.

9. The apparatus of claim 8, wherein the comparison module is further configured to not compare one of the first plurality of data objects with the data object of the second plurality of data objects in response to a determination that the data object of the second plurality of data objects is already identified as one of the common data objects.

10. An apparatus to compare data objects, the apparatus comprising:
a comparison module configured to perform a single double-for loop to compare a first plurality of data objects with a second plurality of data objects;
a bitmask module configured to create a first bitmask corresponding to the first plurality of data objects and to create a second bitmask corresponding to the second plurality of data objects; and
an identification module configured to identify in the first and second bitmasks every common data object within the first and second pluralities of data objects based on the single comparison.

11. The apparatus of claim 10, further comprising a pre-comparison module to identify one of the common data objects of the second plurality of data objects prior to an anticipated comparison including the same common data object.

12. The apparatus of claim 11, wherein the comparison module is configured to exclude one of the common data objects from a subsequent comparison of the first plurality of data objects with the second plurality of data objects.

13. A system to compare data objects, the system comprising:
a first data structure having a first plurality of data objects;
a second data structure having a second plurality of data objects; and
a comparison apparatus configured to perform a single comparison of each of a first plurality of data objects with each of a second plurality of data objects and to identify every common data object within the first and second data structures based on the single comparison.

14. The system of claim 13, further comprising a bitmask module configured to create a first bitmask corresponding to the first data structure and a second bitmask corresponding to the second data structure, the first and second bitmasks configured to store a common data object identifier corresponding to one of the common data objects.

15. The system of claim 14, further comprising an electronic storage device configured to store the first and second bitmasks.

16. The system of claim 13, wherein the first and second data structures are located on a single data storage device.

17. The system of claim 13, wherein the first and second data structures are located on distinct data storage devices.

18. A signal bearing medium tangibly embodying a program of machine-readable instructions executable by a digital processing apparatus to perform operations to compare data objects, the operations comprising:
performing a single comparison of each of a first plurality of data objects with each of a second plurality of data objects; and
identifying every common data object within the first and second pluralities of data objects based on the single comparison.

19. The signal bearing medium of claim 18, wherein the instructions further comprise an operation to create a first bitmask corresponding to a first data structure including the first plurality of data objects and to create a second bitmask corresponding to a second data structure including the second plurality of data objects.

20. The signal bearing medium of claim 19, wherein the instructions further comprise an operation to create a first plurality of common data object indicators within the first bitmask and to create a second plurality of common data object indicators within the second bitmask, each of the common data object indicators corresponding to a respective data object within the first and second pluralities of data objects.

21. The signal bearing medium of claim 20, wherein the instructions further comprise an operation to initialize all of the common data object indicators within the first and second bitmasks to indicate all unique data objects within both the first and second pluralities of data objects.

22. The signal bearing medium of claim 21, wherein the instructions further comprise an operation to initialize all of the common data object indicators to zero, where zero indicates by default that all of the data objects within the first and second pluralities of data objects are unique data objects.

23. The signal bearing medium of claim 20, wherein the instructions further comprise an operation to set a first common indicator within the first bitmask and to set a second common indicator within the second bitmask in response to identifying one of the common data objects, the first and second common indicators corresponding to the same common data object.

24. The signal bearing medium of claim 23, wherein the instructions further comprise an operation to set the first and second common indicators to one, where one indicates the same common data object.

25. The signal bearing medium of claim 18, wherein the instructions further comprise an operation to determine, prior to comparison of a data object of the first plurality of data objects and a data object of the second plurality of data objects, if the data object of the second plurality of data objects is already identified as one of the common data objects.

26. The signal bearing medium of claim 25, wherein the instructions further comprise an operation to not compare one of the first plurality of data objects with the data object of the second plurality of data objects in response to a determination that the data object of the second plurality of data objects is already identified as one of the common data objects.

27. The signal bearing medium of claim 18, wherein the instructions further comprise an operation to perform a single double-for loop to compare the first plurality of data objects with the second plurality of data objects.

28. The signal bearing medium of claim 27, wherein the instructions further comprise an operation to identify one of the common data objects of either of the first or second pluralities of data objects prior to an anticipated comparison including the same common data object.

29. The signal bearing medium of claim 28, wherein the instructions further comprise an operation to exclude one of the common data objects from a subsequent comparison of the first plurality of data objects with the second plurality of data objects.

30. A method for comparing data objects, the method comprising:
performing a single comparison of each of a first plurality of data objects with each of a second plurality of data objects, the first and second pluralities of data objects; and
identifying every common data object within the first and second pluralities of data objects based on the single comparison.

31. The method of claim 30, further comprising creating a first bitmask corresponding to a first data structure including the first plurality of data objects and creating a second bitmask corresponding to a second data structure including the second plurality of data objects.

32. The method of claim 31, further comprising creating a first plurality of common data object indicators within the first bitmask and creating a second plurality of common data object indicators within the second bitmask, each of the common data object indicators corresponding to a respective data object within the first and second pluralities of data objects.

33. The method of claim 32, further comprising initialize all of the common data object indicators within the first and second bitmasks to indicate all unique data objects within both the first and second pluralities of data objects.

34. The method of claim 33, further comprising initializing all of the common data object indicators to zero, where zero indicates by default that all of the data objects within the first and second pluralities of data objects are unique data objects.

35. The method of claim 32, further comprising setting a first common indicator within the first bitmask and setting a second common indicator within the second bitmask in response to identifying one of the common data objects, the first and second common indicators corresponding to the same common data object.

36. The method of claim 35, further comprising setting the first and second common indicators to one, where one indicates the same common data object.

37. The method of claim 30, further comprising determining, prior to comparison of a data object of the first plurality of data objects and a data object of the second plurality of data objects, if the data object of the second plurality of data objects is already identified as one of the common data objects.

38. The method of claim 37, further comprising preventing comparison of one of the first plurality of data objects with the data object of the second plurality of data objects in response to a determination that the data object of the second plurality of data objects is already identified as one of the common data objects.

39. The method of claim 30, further comprising:
performing a single double-for loop to compare the first plurality of data objects with the second plurality of data objects;
identifying a common data object of either of the first or second pluralities of data objects prior to an anticipated comparison including the common data object; and
excluding the common data object from a subsequent comparison of the first plurality of data objects with the second plurality of data objects.

40. An apparatus to facilitate message security, the apparatus comprising:
means for performing a single comparison of each of a first plurality of data objects with each of a second plurality of data objects; and
means for identifying every common data object within the first and second pluralities of data objects based on the single comparison.
